(19) United States
(12) Patent Application Publication
(10) Pub. No.: US 2016/0143388 A1
(43) Pub. Date: May 26, 2016

(54) THERMAL ENERGY TRANSFER DEVICES

(71) Applicant: HenOli Products, LLC, Seattle, WA (US)

(72) Inventor: Ruth Stender, Seattle, WA (US)

(21) Appl. No.: 14/951,172

(22) Filed: Nov. 24, 2015

Related U.S. Application Data
(60) Provisional application No. 62/085,043, filed on Nov. 26, 2014.

(51) Int. Cl. A43B 7/02; B23P 15/26

(52) U.S. Cl. CPC A43B 7/02; B23P 15/26

(57) ABSTRACT

This disclosure relates to devices designed to store thermal energy and methods of making and using such devices, and more particularly to devices designed to store thermal energy to be used to heat garments and footwear, and to be used in therapeutic or other applications. In one embodiment, a thermal energy transfer device can include a plurality of distinct portions of a fabric tube filled with a thermal energy storing substance, the distinct portions separated from one another by separating elements.

### BACKGROUND

1. Technical Field

This disclosure relates to devices designed to store thermal energy and methods of making and using such devices, and more particularly to devices designed to store thermal energy to be used to heat garments and footwear, and to be used in therapeutic or other applications.

2. Description of the Related Art

Devices capable of storing thermal energy can be useful in various applications. For example, devices capable of storing thermal energy can be used to heat footwear, so that the footwear is more comfortable when put on a user's foot and so that the footwear is more pliable and thus easier to put on the user's foot. As one specific example, devices capable of storing thermal energy can be used to heat ski boots, which many users find uncomfortable and difficult to put on their feet due to the low temperature and associated rigidity of the boots.

Existing products for storing thermal energy to heat ski boots suffer from various drawbacks. For example, some existing products can be difficult to get all the way into a ski boot, such that the toe box of the boot cannot be adequately heated. Some products come in specific shapes and sizes that make it difficult to fill the interior of the boot with the product, thereby reducing the effectiveness of the product. Some products are undesirably fragile and store an unsatisfactory amount of thermal energy. Thus, much room for improvement in such products exists.

### BRIEF SUMMARY

One embodiment of the present disclosure is directed to a thermal energy transfer device that is configured to warm a user's footwear prior to the user inserting their foot into the footwear. The thermal energy transfer device includes a fabric tube that is filled with a heat retaining material that is separated into segments. For example, the fabric tube is separated into a plurality of rice-filled round segments. Each segment is separated by a clasp, band, or other clamping device that keeps rice of one segment separate from rice in an adjacent segment.

The present disclosure is also directed to a thermal energy transfer device that includes a fabric tube having first, second, and third portions. The first and second portions are filled with a first quantity of a thermal energy storing substance and a second quantity of the thermal energy storing substance, respectively. The device also includes first and second separating elements that separate the first portion of the fabric tube, the second portion of the fabric tube, and the third portion of the fabric tube. The separating elements also maintain physical separation of the first and second quantities of the thermal energy storing substance.

In one embodiment, the fabric tube includes a ripstop nylon fabric tube. The ripstop nylon fabric tube may be porous or may be waterproof. In another embodiment, the fabric tube includes a polyester fabric tube. In one embodiment, the thermal energy storing substance may be rice, sand, aggregate, a pebble mix, stones, clay, flaxseed, corn, or silica. In one embodiment, the first separating element is a knot in the fabric tube. In another embodiment, the first separating element is a clamp.

The present disclosure is also directed to a method that includes making a thermal energy transfer device by forming a fabric tube from a sheet of fabric, such as by coupling a first edge of the sheet of fabric to a second edge of the sheet of fabric. The method also includes filling a first portion of the fabric tube with a thermal energy storing substance and then separating the first portion of the fabric tube from another portion of the fabric tube with a separating element. The method includes repeatedly filling portions of the fabric tube and separating those portions from other portions with separating elements until a desired number of portions are created.

In one embodiment, forming the fabric tube includes sewing a first edge of the sheet of fabric to a second edge of the sheet of fabric. In another embodiment, forming the fabric tube includes sewing a rounded bottom end of the fabric tube shut. In another embodiment, the method also includes, after forming the fabric tube, turning the fabric tube inside-out. In another embodiment, the method also includes forming a top-most distinct portion of the thermal energy transfer device and forming a handle, at an end of the fabric tube adjacent to the top-most distinct portion, from the sheet of fabric. In another embodiment, the method also includes, after forming the handle, tying a knot in the handle and cinching the knot over the top-most distinct portion.

### BRIEF DESCRIPTION OF THE SEVERAL VIEWS OF THE DRAWINGS

FIG. 1A illustrates one embodiment of a thermal energy transfer device.

FIG. 1B illustrates components of the thermal energy transfer device of FIG. 1A at a larger scale.

FIG. 1C illustrates components of the thermal energy transfer device of FIG. 1A at a larger scale.

FIG. 2A illustrates the thermal energy transfer device of FIGS. 1A-1C positioned within a ski boot.

FIG. 2B illustrates the thermal energy transfer device of FIGS. 1A-1C positioned within a rain boot.

FIG. 2C illustrates the thermal energy transfer device of FIGS. 1A-1C positioned within a shoe.

FIG. 3 illustrates another embodiment of a thermal energy transfer device.

FIG. 4 illustrates a therapeutic device including two thermal energy transfer devices.

FIG. 5A illustrates one stage in a method of fabricating a thermal energy transfer device.

FIG. 5B illustrates another stage in the method of fabricating a thermal energy transfer device of FIG. 5A.

FIG. 5C illustrates another stage in the method of fabricating a thermal energy transfer device of FIGS. 5A-5B.

FIG. 5D illustrates another stage in the method of fabricating a thermal energy transfer device of FIGS. 5A-5C.

FIG. 5E illustrates another stage in the method of fabricating a thermal energy transfer device of FIGS. 5A-5D.

### DETAILED DESCRIPTION

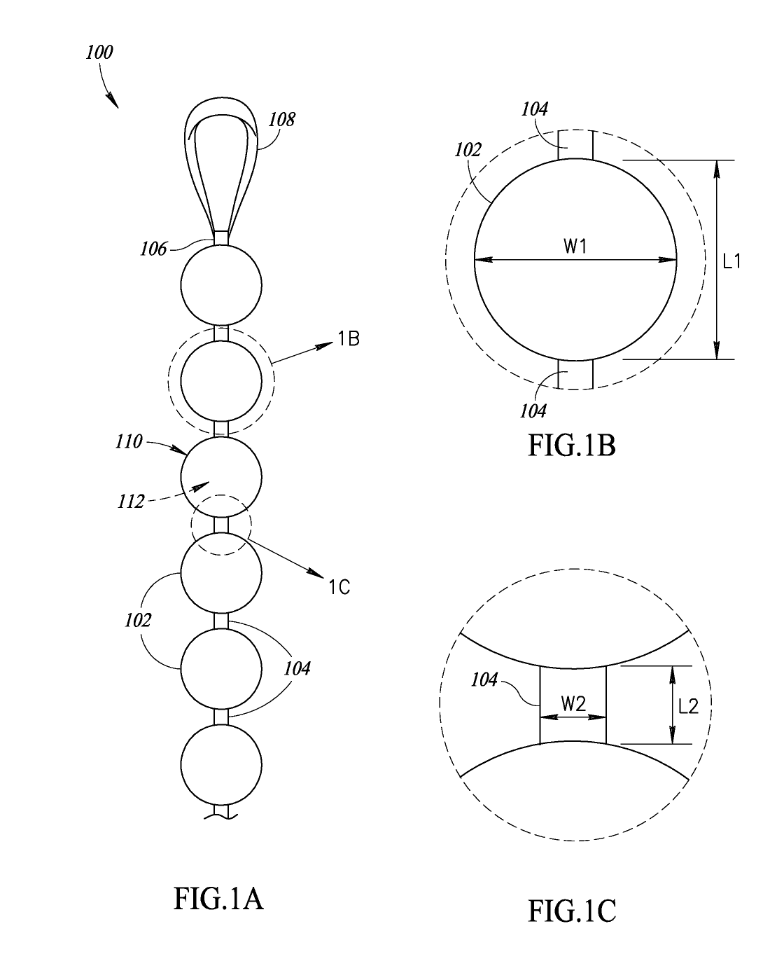

FIGS. 1A-1C illustrate a first embodiment of an apparatus that includes a thermal energy transfer device 100 configured to be heated and reheated for repeated use by a user. The device 100 may be a boot warmer or footwear-heating device 100 configured to be inserted into a user's footwear to heat the footwear prior to use by the user. Alternatively, the device 100 may be used to warm a portion of the user's body. The thermal energy transfer device 100 includes an outer fabric tube 110 filled with a thermal energy storing substance 112. The fabric tube 110 is separated into a plurality of distinct portions 102 of the fabric tube 110 that are separated from each other by a plurality of separating elements 104. The plurality of distinct portions 102 have a wide range of motion with respect to each adjacent distinct portion 102, such that the thermal energy transfer device 100 is easily insertable into a variety of different shapes and sizes of footwear. Each of the distinct portions 102 of the fabric tube 110 are filled with the thermal energy storing substance 112 that is configured to be heated and reheated. The thermal energy transfer device includes a handle, such as a looped handle 108 coupled to a first end 106 of the fabric tube 110. Handles such as the handle 108 can be fabricated as described in greater detail below. FIG. 1A illustrates only a portion of the thermal energy transfer device 100 in the vicinity of the first end 106 of the fabric tube 110. This portion includes six linked portions 102 of the fabric tube 110 filled with the thermal energy storing substance 112. The thermal energy transfer device 100 can include any suitable number of linked portions 102, such as in the range of at least 3 to at least 10 portions or up to 40 portions, as an example. An overall length of the device 100 (and thus a volume of an article of footwear it can fill) depends on the number of linked portions provided and a volume of thermal energy storing substance 112 in each portion. As one example, a thermal energy transfer device including 12 linked portions 102 and one handle 108 can have an overall length of about 30 inches. A second end of the thermal energy transfer device 100 (not shown in

FIGS. 1A-1C) can include a terminal linked portion 102 or a terminal separating element 104, and can include or not include a handle similar to handle 108.

Each of the distinct portions 102 can be a ball, a round segment, a pocket, or other shaped segmented section of the device 100, which includes a quantity of the thermal energy storing substance 112 positioned within the portion of the fabric tube 110. FIG. 1 B illustrates one of the distinct portions 102 of the thermal energy transfer device 100 between two separating elements 104 at a larger scale. The distinct portion 102 can have any of various suitable shapes. For example, the distinct portion 102 can have a geometric shape including a sphere, a cube, a rectangular prism, a cylinder, etc., or can have an irregular shape. The distinct portion 102 can have a length (i.e., a distance between successive separating elements 104) L1 and a width (e.g., along a dimension perpendicular to its length L1) W1. In embodiments in which the distinct portion 102 has a spherical or cubic shape, L1 can be the same as W1. As specific examples, the distinct portions 102 can have spherical shapes having diameters of between 0.5 inches and 5 inches, or of between 1 inch and 2 inches, or of 1.5 inches, such that W1=L1=1.5 inches. In one embodiment, spherical distinct portions 102 can have such diameters to within a ±0.1 inches margin of error. In other embodiments, L1 and W1 can be, but need not be, the same. FIG. 1A illustrates a thermal energy transfer device 100 including distinct portions 102 having substantially the same size and shape as one another. In other embodiments, the distinct portions 102 of the thermal energy transfer device can have different sizes and different shapes from one another.

FIG. 1C illustrates a separating element 104 of the thermal energy transfer device 100 at a larger scale. The separating element 104 is shown schematically in FIG. 1C and can include any of various suitable elements capable of separating the distinct portions 102, such as by cinching the fabric tube 110 at locations between the distinct portions 102. For example, the separating element 104 can include a knot in the fabric tube 110, a nylon spacer, a clamp such as a cotton, nylon, or polyester fabric clamp or tie, a clip, a thread, an adhesive such as a glue, a melted portion of the fabric tube 110, an o-ring such as a rubber o-ring, rubber bands, or any other suitable separating element. The separating element 104 can physically separate two linked distinct portions 102, physically separate the substance 112 within one linked distinct portion 102 from another linked distinct portion 102, or can physically separate the substance 112 within one linked distinct portion from the substance 112 within another linked distinct portion 102. The separating element 104 can also prevent the substance 112 within a first distinct portion 102 from migrating to a second distinct portion 102. Separating elements such as clamps can be advantageous because they need not be threaded over the fabric tube 110, while separating elements such as nylon spacers can be advantageous because they provide a smoother surface against the fabric tube, reducing the likelihood of the separating element damaging the fabric tube 110.

The separating element 104 can have a length (i.e., a distance between successive distinct portions 102) L2 and a width (e.g., along a dimension perpendicular to its length L2) W2. In one embodiment, L2 can be the same as W2, while in other embodiments, L1 can be different from W1. As one specific example, the separating elements 104 can include nylon spacers having an inside diameter of 6.3 mm, an outside diameter of 10 mm, and a length of 5 mm. FIG. 1A schematically illustrates the separating elements 104 having the same structure and substantially the same size and shape as one another. In some embodiments, however, the separating elements 104 of the thermal energy transfer device 100 can include different structures, and can have different sizes and different shapes from one another. For example, one separating element 104 of the device 100 can include a knot in the fabric tube 110 while another separating element 104 of the device 100 can include a clamp.

The fabric tube 110 can include any type of fabric, textile, cloth, or other flexible woven material, whether synthetic or natural. For example, the fabric tube 110 can include wool, flax, or cotton. In one embodiment, the fabric tube 110 is waterproof and prevents water or other fluids being absorbed by the thermal energy storing substance 112 so as to prevent or reduce molding or other deterioration of the substance 112. In other embodiments, the fabric tube 110 is porous or not waterproof so that water or other fluids can flow into and out of the substance 112, facilitating drying of the substance 112 if it becomes wet. In one embodiment, the fabric tube 110 includes material which can be washed in typical home washing machines. In one embodiment, the fabric tube 110 can include a ripstop or a non-ripstop fabric, such as a cotton, silk, polyester, polypropylene, or nylon ripstop or non-ripstop fabric. Ripstop fabrics can be advantageous because they are typically more resistant to tearing or ripping than many other fabrics.

Each of the distinct portions 102 of the fabric tube 110 of the device 100 can be filled with a thermal energy storing substance 112. Examples of suitable substances 112 include sand, rice, aggregate (such as ¼ minus crushed rock), pebble mix, stones, clay, flaxseed, corn, silica, or other similarly small-grained or granular materials. Additional examples of suitable substances 112 include large-grained or solid materials such as heat-retaining materials cast or molded in desired shapes such as spherical shapes. In an alternative, each distinct portion 102 may be a single ball or feature that is heatable; the single feature could be hollow or solid. In one embodiment, silica can be particularly desirable because it is suitable for absorbing moisture as well as retaining heat. Suitable substances 112 can be scented or unscented. In one embodiment, each of the distinct portions 102 of the device 100 are filled with a single such substance 112. In other embodiments, each of the distinct portions 102 can be filled with a single combination of such substances 112. In yet other embodiments, some or all of the distinct portions 102 can be filled with a different one of such substances 112 or a different combination of such substances 112. Each distinct portion 102 can be filled with between 0.5 and 5 tablespoons, or with between 1 and 3 tablespoons, or with 2 tablespoons of the thermal energy storing substance 112. In one embodiment, the distinct portions 102 can be filled with such quantities of the substance 112 to within a ±0.1 tablespoon margin of error.

The handle 108 can include an extension of the fabric tube 110, folded back and sewn to create a loop, as described in greater detail below. The handle 108 can be used by a user to hold the device 100, or can be used to hang the device, such as on a peg, rack, or hook, such as for storage or to allow the device 100 to air-dry.

Because the device 100 includes distinct portions 102 of the fabric tube 110 separated by separating elements 104, it is relatively flexible along its length. For example, each of the linked portions 102 can move and rotate with respect to each adjacent linked portion 102. Thus, by increasing the number of linked portions 102 separated by the separating elements 104, the device 100 can be made increasingly flexible.

One method of using the thermal energy transfer device 100 includes heating the device 100, such as by microwaving the device 100, submerging the device 100 in hot water, placing the device 100 in a heated oven, etc. The length of time of heating will depend on the substance 112 in the portions 102. The method further includes inserting the heated device 100 into footwear, sealing the footwear to retain more heat in the footwear during the heating process, and allowing the heated device 100 to sit in the sealed footwear for a period of time, such as until thermal equilibrium between the device 100 and the footwear is reached, or until a user desires to use the footwear. In embodiments in which the footwear is initially colder than the heated device 100, thermal energy held in the device 100 can be transferred from the device 100 to the footwear as the device 100 sits in the footwear, heating the footwear and resulting in a warmer, more pliable, more comfortable article of footwear.

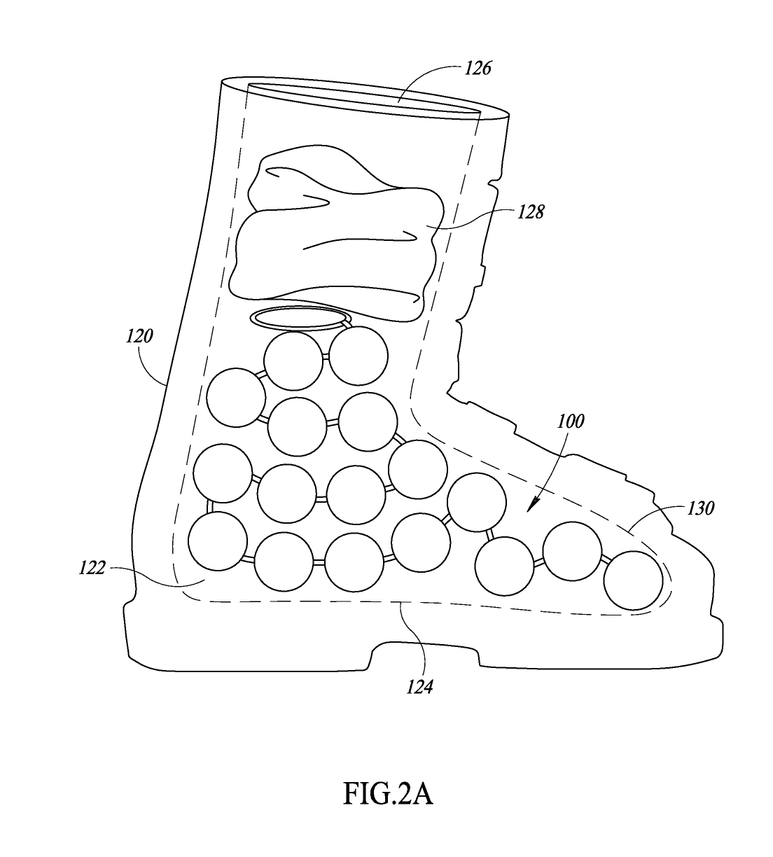

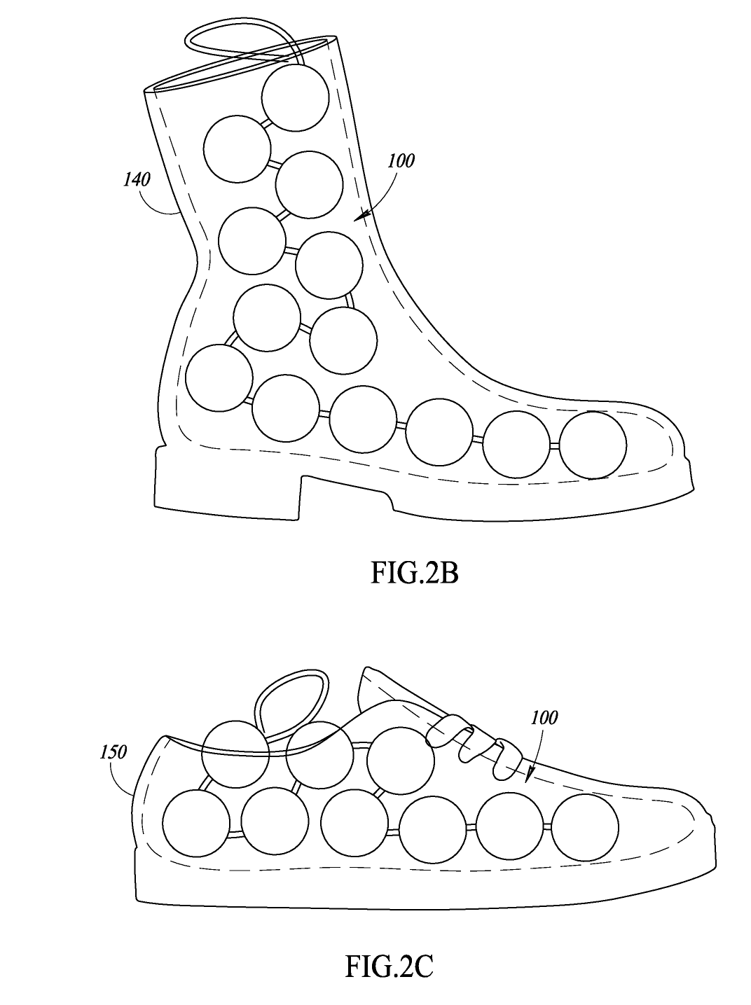

FIGS. 2A-2C illustrate the device 100 in use. For example, FIG. 2A illustrates the device 100 positioned within a ski boot 120. The boot 120 includes an outer shell made of relatively stiff, rigid plastic material, an inner liner provided for insulation, and an open internal space 122 bounded by the dashed line 124, designed to accommodate a user's foot. The device 100 in this embodiment is sealed in the boot 120 by a sealing element 128, which seals the opening 126 of the boot 120. Any suitable device can be used as the sealing element 128, such as a piece of fabric, a rag, an article of clothing such as a sock, etc. As shown in FIG. 2A, due to the flexibility of the device 100 and the relatively small size of its linked portions 102, the device 100 fits easily into the toe box 130 (i.e., the portion of the boot 120 designed to accommodate a user's toes) of the boot 120, and coils around within the internal space 122 of the boot 120 to fill the boot 120.

FIG. 2B illustrates the device 100 positioned within a rain boot 140, and FIG. 2C illustrates the device 100 positioned within a shoe 150. Because of the relative flexibility of the device 100, because the distinct portions 102 are relatively conformable and moveable with respect to each other, and because the device 100 can be inserted into relatively narrow spaces, it can be used in a wide variety of footwear items, regardless of shape and size of the footwear. In addition to the ski boot, rain boot, and shoe of FIGS. 2A-2C, the device 100 can be used with snow boots, work boots, riding boots, or any other style of boot, shoe, slipper, or footwear generally, regardless of whether it is a child- or adult-sized boot.

A method of making the thermal energy transfer device 100 can include obtaining a fabric tube or forming a fabric tube from a sheet of fabric by coupling a first edge of the sheet of fabric to a second edge of the sheet of fabric, and then sealing one end of the fabric tube shut. Once the fabric tube has been obtained, a first portion of the tube is filled with a first quantity of the thermal energy storing substance, and a first separating element is used to separate the first portion of the tube from an unfilled portion of the tube. A second portion of the tube is then filled with the energy storing substance, and a second separating element is used to separate the second portion of the tube from an unfilled portion of the tube. This process is repeated until a desired number of portions have been formed.

In one specific example, the method can include starting with a sheet of fabric measuring 6″×50″, sewing it into a tube, closing a first end of the tube, filling a portion of the tube with the substance, applying a separating element, and repeating, then sewing a second end shut while creating a loop to be used as a handle and for hanging. The final size can be approximately 30″ in length.

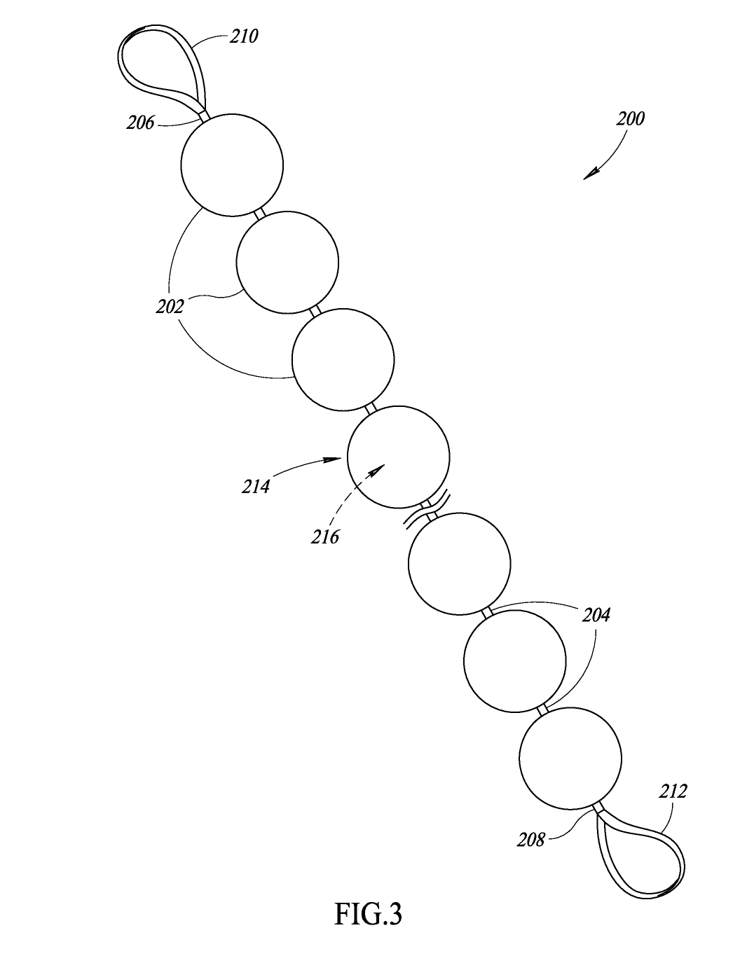

FIG. 3 illustrates another embodiment of a thermal energy transfer device 200. The thermal energy transfer device 200 can be very similar to thermal energy transfer device 100, and can include an outer fabric tube 214 filled with a thermal energy storing substance 216. The fabric tube 214 can be separated into a plurality of distinct portions 202 of the fabric tube 214, forming a set of linked portions 202 of the fabric tube 214, such as by a plurality of separating elements 204. Each of the distinct portions 202 of the fabric tube 214 can be filled with the thermal energy storing substance 216. A first handle, such as a first looped handle 210, can be coupled to a first end 206 of the fabric tube 214 in a manner similar to that described below, and a second handle, such as a second looped handle 212, can be coupled to a second end 208 of the fabric tube 214 in a manner similar to that described below. The handles provide a convenient way for a user to hold the device 200 without having to hold heated portions 202, as the heated portions 202 may be too warm to comfortably handle with one's hands.

The device 200 can be used in the methods described above. Additionally, the device 200 can be used as a therapeutic device, such as by using the pair of handles 210, 212 to hold the device 200 and to move the distinct portions 202 across a user's body, such as along the user's legs or back.

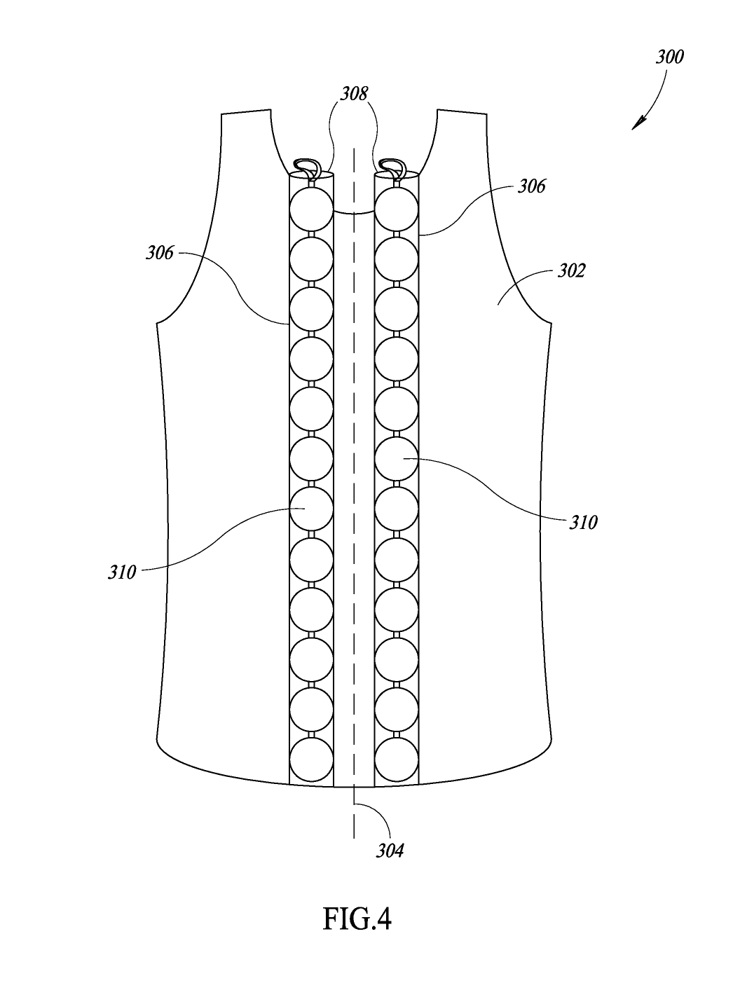

FIG. 4 illustrates a therapeutic device 300 including two thermal energy transfer devices 310. Therapeutic device 300 includes a vest or shirt 302, such as a t-shirt, a tank top, etc., having a central line of symmetry 304. The device 300 can also include two sleeves, or pockets, or slots 306 which can be coupled to a back portion of the shirt 302 (e.g., a portion designed to contact a user's back when the device 300 is worn) so as to run parallel or substantially parallel to the line of symmetry 304 and so as to be spaced apart from the line of symmetry 304. The sleeves 306 can be closed at their respective bottom ends (i.e., the ends near the waist of the shirt 302) and can have openings 308 at their respective top ends (i.e., the ends near the neck of the shirt 302). Thus, the thermal energy transfer devices 310 can be inserted into the sleeves 306 and removed therefrom through the openings 308. In one embodiment, the thermal energy transfer devices 310 can be similar to the thermal energy transfer device 100 or the thermal energy transfer device 200. For example, both thermal energy transfer devices 310 can include a thermal energy transfer device 100, or both thermal energy transfer devices 310 can include a thermal energy transfer device 200, or one thermal energy transfer device 310 can include a thermal energy transfer device 100 while the other thermal energy transfer device 310 includes a thermal energy transfer device 200.

A method of using the device 300 can include heating the thermal energy transfer devices 310, such as by the methods described above, inserting the thermal energy transfer devices 310 into the sleeves 306, and putting the device 300 on a user. An alternative method of using the device 300 can include inserting the thermal energy transfer devices 310 into the sleeves 306, then heating the entire device 300, such as by the methods described above, and putting the device 300 on a user. In either embodiment, when the device 300 is worn by a user, the thermal energy transfer devices 310 lie adjacent to the user's spine, providing therapeutic heat to the user's tissues in that area.

A kit can include several thermal energy transfer devices similar to thermal energy transfer devices 100 and 200, and portions of a therapeutic device similar to therapeutic device 300. For example, a kit can include thermal energy transfer devices provided with various numbers of linked portions, with linked portions of various sizes, and with various types of separating elements. In particular, a kit can include thermal energy transfer devices having different separating elements, such as a first thermal energy transfer device having a knot in its fabric tube, a second thermal energy transfer device having a black nylon spacer having an inside diameter of 6.3 mm, an outside diameter of 10 mm, and a length of 5 mm, a third thermal energy transfer device having a white nylon spacer having an inside diameter of 6.3 mm, an outside diameter of 10 mm, and a length of 3 mm, and a fourth thermal energy transfer device having a black rubber o-ring having an inside diameter of 5 mm, an outside diameter of 10 mm, and a length of 2.5 mm.

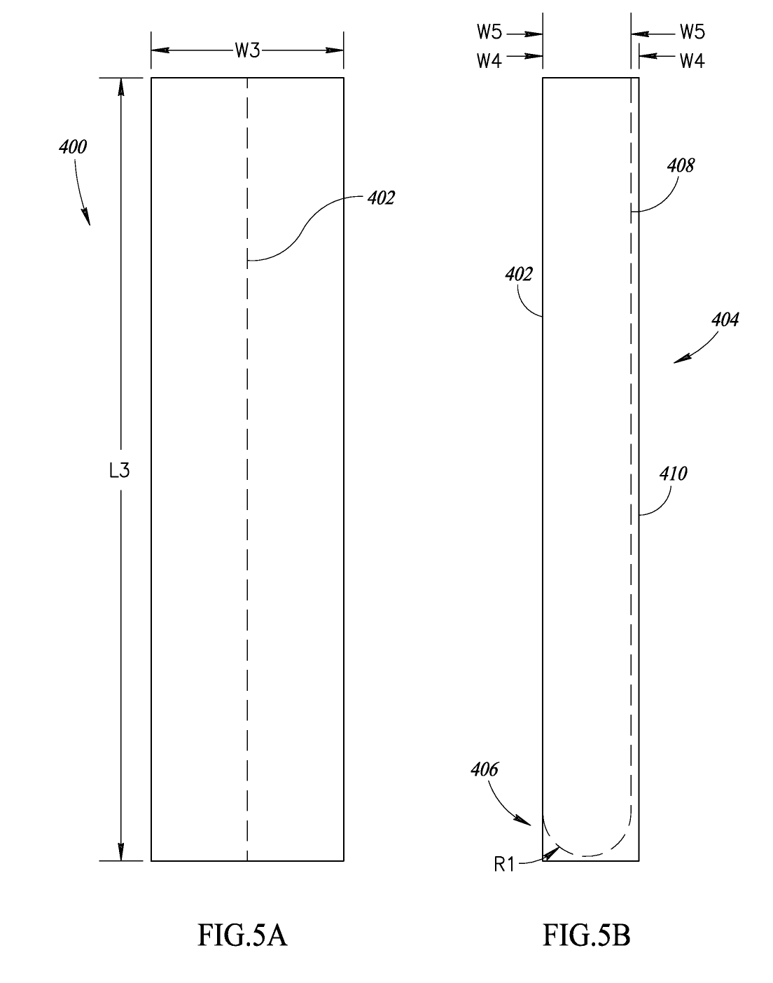

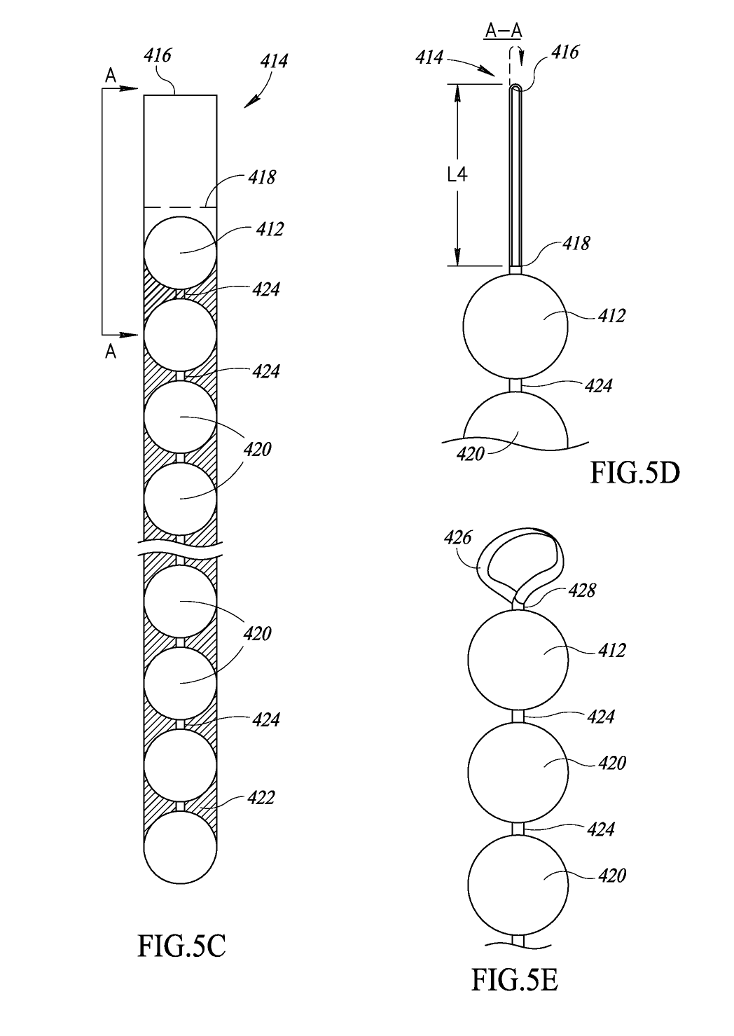

FIGS. 5A-5E illustrate one example method of fabricating a thermal energy transfer device similar to the thermal energy transfer device 100. As shown in FIG. 5A, a sheet of fabric 400 can be cut to a suitable or desired shape and size, such as a rectangular shape having a suitable or desired length L3 and a suitable or desired width W3. As specific examples, L3 can be between about 20 and about 80 inches, or about 50 inches, and W3 can be between about 3 and about 9 inches, or about 6 inches. The sheet of fabric 400 can then be folded in half lengthwise along a longitudinal centerline or long axis of symmetry 402 to form a double layer sheet of fabric 404 having a width W4, which can be half of W3, as shown in FIG. 5B. A stich line 408 can then be marked onto the double layer sheet of fabric 404 adjacent to an open edge 410 of the double layer sheet of fabric 404 opposite to a folded edge of the double layer sheet of fabric 404 formed along the long axis of symmetry 402.

The stitch line 408 can be set in from the open edge 410 by a small distance, such as between about ⅛ inch and about 1 inch, or about ¼ inch or about ½ inch. A width W5 between the folded edge of the double layer sheet of fabric 404 and the stitch line 408 can be about 2.5 inches. As the stitch line 408 approaches a bottom end 406 of the double layer sheet of fabric 404, the stitch line 408 can curve with a radius of curvature R1, which can be about half of the width W5, or about 1.25 inches. Thus, the stitch line 408 can include a linear portion parallel to the open edge 410, and a curved portion at the bottom end 406, wherein the curved portion forms a half circle extending from a bottom end of the linear portion to the folded edge of the double layer sheet of fabric 404. The method can continue by pinning the material along the stitch line 408, stitching along the stitch line 408, such as from a top end to toward the bottom end 406, and cutting off or otherwise removing excess material beyond the stitch line 408 to leave an elongate fabric tube having a closed and rounded bottom end.

The method can continue by turning the elongate fabric tube inside-out, so that the seam sewn along the stitch line 408 is inside the elongate tube. For example, an elongate rod or wooden dowel having a diameter less than that of the fabric tube can be pushed against the bottom end 406 to push the bottom end 406 into and through the tube, and the elongate tube can be rolled over the elongate rod or wooden dowel, until the tube is inside-out. A first portion (e.g., about 2 tablespoons) of a thermal energy storing material can then be inserted into the elongate tube through an open top end of the tube, and can be allowed to fall into the tube until it rests at the bottom 406 of the tube. The fabric tube can then be cinched over the thermal energy storing material to form a first distinct portion of a thermal energy transfer device, and a first separating element (e.g., any of those described elsewhere herein) can be applied to the fabric tube above the first distinct portion to separate it and the thermal energy storing material held therein from the rest of the elongate tube. This process can be repeated until a desired or suitable number of distinct portions have been formed.

FIG. 5C illustrates that a plurality of distinct portions 420 can be formed from the elongate tube by cinching the fabric of the tube in at the hatched regions 422 (which represent locations where the fabric is present before, but not after, the cinching) using a plurality of separating elements 424. Once a top-most distinct portion 412 has been filled with a thermal energy storing material, a top end 414 of the elongate tube, which can be about 6 inches or about 10 inches long, can be folded over on itself at fold line 416 so that a terminal end 418 of the tube is adjacent to the top-most distinct portion 412. The terminal end 418 can then be pinned and then stitched to the underlying fabric adjacent to the top-most distinct portion 412 to separate the top-most distinct portion 412 and the thermal energy storing material held therein from the top end 414 of the elongate tube.

The top end 414 of the thermal energy transfer device thus can include a loop of the fabric material 426 having a length L4, which can be about 3 inches or about 5 inches, which loop of the fabric material can form a handle 426 of the device. These elements of the thermal energy transfer device are illustrated in greater detail in FIG. 5D, a side view taken at section A-A illustrated in FIG. 5C.

As illustrated in FIG. 5C, once the top-most distinct portion 412 is sewn shut, it can have a flat top defined by the sew line across the terminal end 418 of the tube. Thus, as shown in FIG. 5E, the handle 426 of the device can then be knotted, and the knot 428 (e.g., an overhand knot) can be cinched down over the top-most distinct portion 412, so that the top end of the top-most distinct portion 412 is rounded and has a shape more closely matching the shapes of the rest of the distinct portions 420. A thermal energy transfer device fabricated by such a method can have an overall length of about 30 inches and can include 12 distinct portions.

U.S. provisional patent application no. 62/085,043, filed Nov. 26, 2014, to which this application claims priority, is hereby incorporated herein by reference in its entirety. The various embodiments described above can be combined and modified to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus, comprising:
a thermal energy transfer device including:
a fabric tube having a first portion filled with a first quantity of a thermal energy storing substance, a second portion filled with a second quantity of the thermal energy storing substance, and a third portion;
a first separating element that separates the first portion of the fabric tube from the second portion of the fabric tube and maintains physical separation of the first quantity of the thermal energy storing substance and the second portion of the fabric tube; and
a second separating element that separates the second portion of the fabric tube from the third portion of the fabric tube and maintains physical separation of the second quantity of the thermal energy storing substance and the third portion of the fabric tube.

2. The apparatus of claim 1, wherein the fabric tube includes a ripstop nylon fabric tube.

3. The apparatus of claim 2, wherein the ripstop nylon fabric tube is porous.

4. The apparatus of claim 2, wherein the ripstop nylon fabric tube is waterproof.

5. The apparatus of claim 1, wherein the fabric tube is a polyester fabric tube.

6. The apparatus of claim 1, wherein the thermal energy storing substance is rice.

7. The apparatus of claim 1, wherein the thermal energy storing substance is sand.

8. The apparatus of claim 1, wherein the first separating element is a knot in the fabric tube.

9. The apparatus of claim 1, wherein the first separating element is a clamp.

10. A method, comprising:
making a thermal energy transfer device by:
forming a fabric tube from a sheet of fabric by coupling a first edge of the sheet of fabric to a second edge of the sheet of fabric;
filling a first portion of the fabric tube with a first quantity of a thermal energy storing substance;
separating the first portion of the fabric tube from a second portion of the fabric tube with a first separating element to maintain physical separation of the first quantity of the thermal energy storing substance and the second portion of the fabric tube;
filling the second portion of the fabric tube with a second quantity of the thermal energy storing substance; and
separating the second portion of the fabric tube from a third portion of the fabric tube with a second separating element to maintain physical separation of the second quantity of the thermal energy storing substance and the third portion of the fabric tube.

11. The method of claim 10, wherein forming the fabric tube includes sewing the first edge of the sheet of fabric to the second edge of the sheet of fabric.

12. The method of claim 10, wherein forming the fabric tube includes sewing a rounded bottom end of the fabric tube shut.

13. The method of claim 10, further comprising, after forming the fabric tube, turning the fabric tube inside-out.

14. The method of claim 10, further comprising forming a top-most distinct portion of the thermal energy transfer device and forming a handle, at an end of the fabric tube adjacent to the top-most distinct portion, from the sheet of fabric.

15. The method of claim 14, further comprising, after forming the handle, tying a knot in the handle and cinching the knot over the top-most distinct portion.
